(19) United States
(12) Patent Application Publication
(10) Pub. No.: US 2025/0180848 A1
(43) Pub. Date: Jun. 5, 2025

(54) METHODS FOR FORMING A DEMARCATION ON AN OPTICAL CABLE AND RELATED OPTICAL CABLE ASSEMBLIES

(71) Applicant: CORNING RESEARCH & DEVELOPMENT CORPORATION, Corning, NY (US)

(72) Inventors: Kenneth Todd James, Lenoir, NC (US); Boyang Lin, Richardson, TX (US); Alvin John McDonald, Rutherford College, NC (US); Hieu Vinh Tran, Charlotte, NC (US)

(21) Appl. No.: 18/947,400

(22) Filed: Nov. 14, 2024

Related U.S. Application Data
(60) Provisional application No. 63/604,294, filed on Nov. 30, 2023.

(51) Int. Cl. G02B 6/44

(52) U.S. Cl. CPC G02B 6/4486; G02B 6/448

(57) ABSTRACT

In one embodiment, a method of preparing an optical cable includes stripping a jacket of the optical cable to expose a buffer tube and one or more strength members, trimming the one or more strength members to a first distance d₁ from an end of the jacket, trimming the buffer tube to a second distance d₂ from an end of the one or more strength members to expose a plurality of optical fibers, grouping the plurality of optical fibers, applying a heat shrink tube over the buffer tube, applying heat to the heat shrink tube, applying adhesive to a first end and a second end of the heat shrink tube, and curing the adhesive.

### PRIORITY APPLICATION

This application claims the benefit of priority of U.S. Provisional Application No. 63/604,294, filed on Nov. 30, 2023, the content of which is relied upon and incorporated herein by reference in its entirety.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent.

In optical cable assemblies having an optical cable with optical fibers, the optical fibers are commonly secured to an optical connector by potting using an adhesive, which forms a fiber demarcation within the optical connector. However, because the potting step is one of the last steps in the optical cable assembly fabrication process, there is a risk of pre-buckling of the optical fibers within the optical connector, which presents an uncertainty of the location of the optical fibers within the optical connector. Pre-buckling of the optical fibers is disadvantageous because it can lead to optical loss.

Accordingly, alternative methods for preparing optical cables that reduce pre-buckling of optical fibers when mating the optical cables to optical connectors may be desired.

### SUMMARY

In one embodiment, a method of preparing an optical cable includes stripping a jacket of the optical cable to expose a buffer tube and one or more strength members, trimming the one or more strength members to a first distance d₁ from an end of the jacket, trimming the buffer tube to a second distance d₂ from an end of the one or more strength members to expose a plurality of optical fibers, grouping the plurality of optical fibers, applying a heat shrink tube over the buffer tube, applying heat to the heat shrink tube, applying adhesive to a first end and a second end of the heat shrink tube, and curing the adhesive.

In another embodiment, a method of preparing an optical cable includes stripping a jacket of the optical cable to expose a buffer tube and one or more strength members, trimming the one or more strength members to a first distance d₁ from an end of the jacket, trimming the buffer tube to a second distance d₂ from an end of the one or more strength members to expose a plurality of optical fibers, grouping the plurality of optical fibers at a location offset from the end of the one or more strength members to arrange the plurality of optical fibers into an order, applying a first adhesive over the buffer tube, applying a tube over the first adhesive and the buffer tube, curing the first adhesive, applying a second adhesive into the tube such that the second adhesive covers a portion of the plurality of optical fibers, and curing the second adhesive.

In another embodiment, an optical cable includes a jacket, one or more strength members within the jacket and extending beyond an end of the jacket by a first distance d₁, a buffer tube within the jacket, wherein the buffer tube extends beyond an end of the one or more strength members by a second distance d₂, a plurality of optical fibers within the buffer tube and extending beyond an end of the buffer tube, a heat shrink tube disposed around the buffer tube, and an adhesive disposed around at least a first end and a second end of the heat shrink tube.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a flowchart of an example method for preparing an optical cable according to one or more embodiments described and illustrated herein.

FIG. 2 illustrates an example optical cable having a jacket stripped according to one or more embodiments described and illustrated herein.

FIG. 3 illustrates an example optical cable having a jacket stripped and strength members trimmed according to one or more embodiments described and illustrated herein.

FIG. 4 illustrates an example optical cable having a jacket stripped and strength members and a buffer tube trimmed according to one or more embodiments described and illustrated herein.

FIG. 5 the optical cable of FIG. 4 with a plurality of optical fibers clamped according to one or more embodiments described and illustrated herein.

FIG. 6 illustrates the optical cable of FIG. 5 with a heat shrink tube applied to the buffer tube according to one or more embodiments described and illustrated herein.

FIG. 7 illustrates the optical cable of FIG. 6 after heat is applied to the heat shrink tube according to one or more embodiments described and illustrated herein.

FIG. 8 illustrates the optical cable of FIG. 7 with adhesive applied to a first end of the heat shrink tube according to one or more embodiments described and illustrated herein.

FIG. 9 the optical cable of FIG. 8 with adhesive applied to a second end of the heat shrink tube according to one or more embodiments described and illustrated herein.

FIG. 10 illustrates a flowchart of another example method of preparing an optical cable according to one or more embodiments described and illustrated herein.

FIG. 11 illustrates an optical cable of FIG. 3 with adhesive applied to the buffer tube according to one or more embodiments described and illustrated herein.

FIG. 12 illustrates the optical cable of FIG. 11 with a tube applied to the buffer tube and filled with adhesive according to one or more embodiments described and illustrated herein.

FIG. 13 illustrates an example optical cable assembly comprising a connector assembly coupled to a prepared optical cable according to one or more embodiments described and illustrated herein.

### DETAILED DESCRIPTION

Embodiments of the present disclosure are directed to methods for preparing an optical cable by forming an initial demarcation prior to securing the optical cable to an optical connector. This initial demarcation minimizes the problem of fiber buckling within a connector prior to the final demarcation by potting the optical fibers to the optical connector. More particularly, in one embodiment the demarcation is formed by applying a heat shrink tube and adhesive to the buffer tube of the optical cable. In another embodiment, a tube is secured to the buffer tube and optical fibers by adhesive.

Various embodiments of methods for preparing optical cables and optical cable assemblies including prepared optical cables.

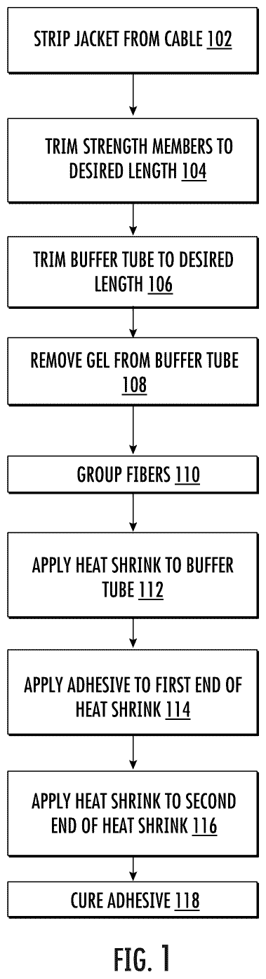

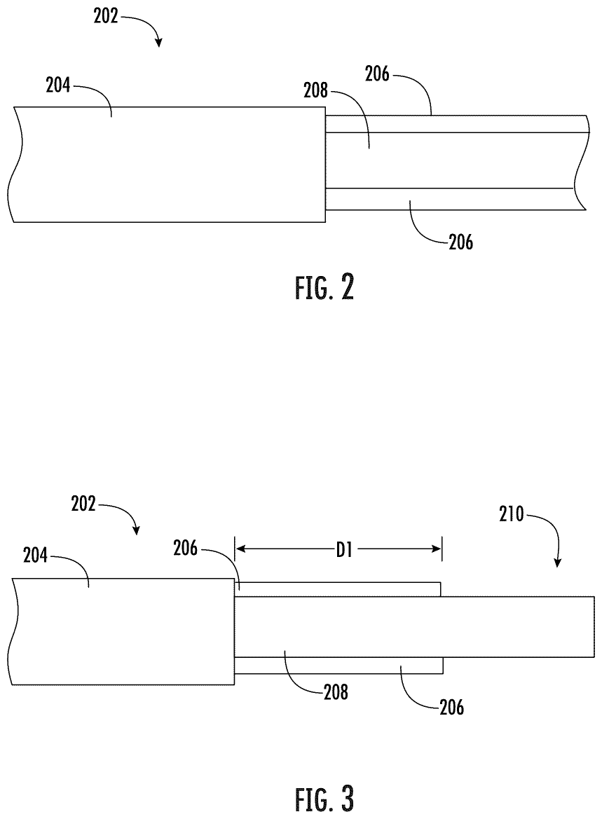

Referring now to FIG. 1, a flowchart illustrating an example method for forming a demarcation in a cable, such as an optical cable 202 shown in FIG. 2, is provided. The demarcation that is described herein is formed on the optical cable 202 prior to insertion of the optical cable into an optical connector, where it is then demarcated with a final demarcation in the connector housing. As stated above, the pre-connector demarcation prevents pre-buckling of optical fibers within the buckling region of the optical connector.

At block 102 the jacket 204 is stripped from the optical cable 202, as shown in FIG. 2. The optical cable 202 may be any known or yet-to-be-developed optical cable. As non-limiting examples, the optical cable 202 may be a round optical cable or a flat optical cable. It should be understood that although embodiments are described in the context of optical cables, the demarcation methods described herein may also be utilized in electrical connectors where there are a plurality of electrically conductive wires (e.g., signal wires) that should be demarcated prior to insertion into a connector housing.

The optical cable 202 may be stripped by any method, such as by a cable stripping tool. Stripping the jacket 204 exposes the internal components of the optical cable 202, which includes a buffer tube 208 and one or more strength members 206. The one or more strength members 206 provide rigidity to the optical cable 202, and prevent it from being bent beyond an allowable bend radius. Embodiments are not limited by the number or type of strength members. As a non-limiting example, the one or more strength members 206 may be glass-reinforced plastic (GRP). As other examples, the one or more strength members 206 may be aramid yarn or metal members.

The buffer tube 208 is a compliant tube that maintains a plurality of optical fibers 210 (see FIG. 3). The buffer tube may be made out of any compliant material, such as plastic.

Referring once again to FIG. 1, at block 104 the one or more strength members 206 are trimmed as shown in FIG. 3 so that they extend from an end of the jacket 204 by a first distance d₁. In some embodiments, the first distance d₁ is within a range of 5 millimeters (mm) to 10 mm, 6 mm to 9 mm, 6 mm to 8 mm, including endpoints, or 7 mm.

At block 106 the buffer tube 208 is trimmed such that the it extends beyond an end of the one or more strength members 206 by a second distance d₂, as shown in FIG. 4. The length of the second distance d₂ determines the length of the demarcation. As non-limiting examples, the second distance d₂ may be 1 mm to 5 mm, 2 mm to 4 mm, 2.5 mm to 3.5 mm, including endpoints, or 3 mm.

The trimming of the buffer tube 208 exposes the plurality of optical fibers 210. Any number of optical fibers 210 may be provided. As one non-limiting example, eight optical fibers 210 are provided.

At block 108 any gel that is present within the buffer tube 208 may be removed. This gel may be removed by use of a needle, for example. Removal of the gel allows for adhesive to wick along the plurality of optical fibers 210 and into the buffer tube, as described in more detail below. It should be understood that gel may not be provided within the buffer tube in some embodiments.

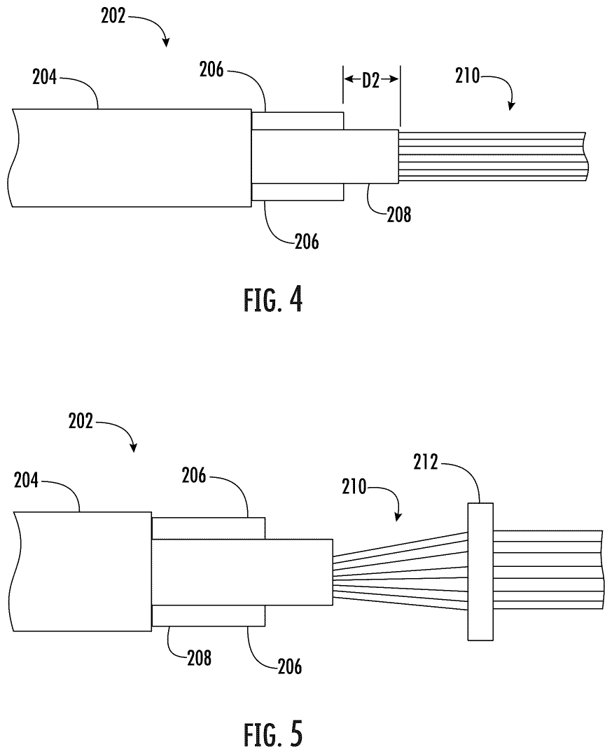

At block 110 the plurality of optical fibers 210 may be optionally grouped into a desired order, such as the order the optical fibers 210 will be arranged within the optical connector. The plurality of optical fibers may be grouped by applying a clamp 212, as shown in FIG. 5. The clamp 212 may include a plurality of grooves (not shown) to receive the plurality of optical fibers 210 to group them without undue damage.

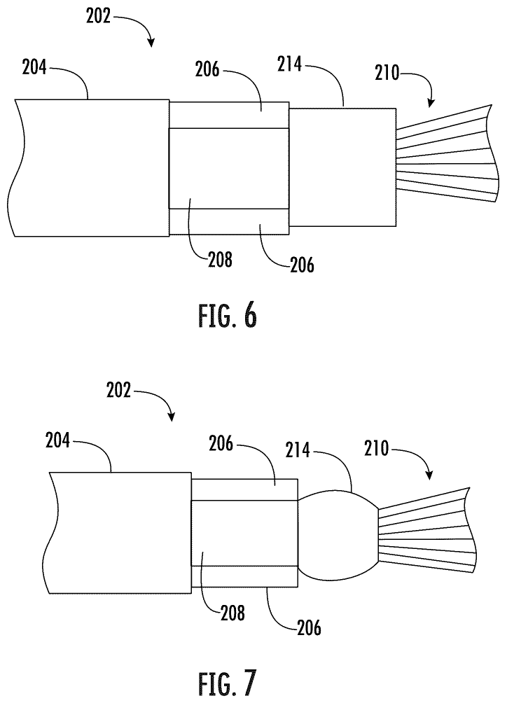

At block 112 a heat shrink tube 214 is disposed over the end of the buffer tube 208 defined by the second distance d₂ as shown by FIG. 6. The heat shrink tube 214 may be made of any suitable heat shrink material, and may have any suitable diameter. As a non-limiting example, the heat shrink tube 214 may have a diameter of about 6 mm. The heat shrink tube 214 has a length that is slightly longer than the second distance d₂.

After placement of the heat shrink tube 214 on the buffer tube 208, heat is applied to the heat shrink tube 214 to reduce its diameter such that it tightly wraps the buffer tube 208, as shown by FIG. 7. The heat may be applied by a heat gun or by any other device that can provide the suitable thermal energy to shrink the heat shrink tube 214.

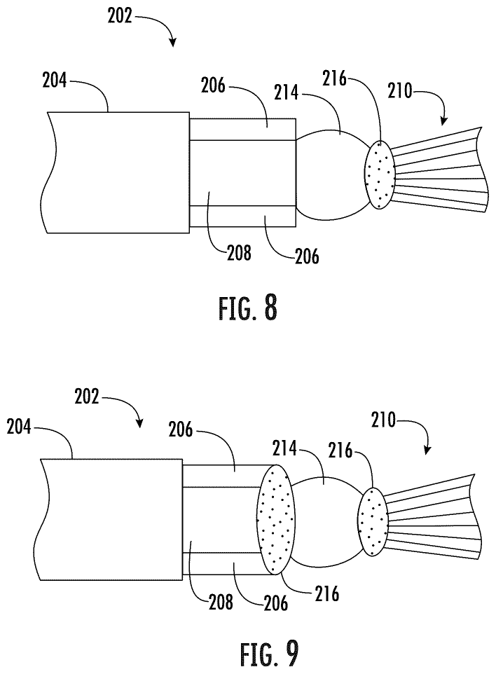

As shown in FIG. 8, an adhesive 216 is applied to a first end of the heat shrink tube 214 at block 114. In the illustrated embodiment, the first end of the heat shrink tube 214 is the end of the heat shrink tube 214 through which the plurality of optical fibers 210 extend. As a non-limiting example, the adhesive may be Loctite® 411 manufactured and sold by Henkle AG & Co. KGaA of Dusseldorf, Germany. It should be understood that other adhesives may be used, such as UV curable adhesive. Adhesive wicks into the buffer tube 208 and over the plurality of optical fibers 210 by capillary force.

FIG. 9 illustrates that an adhesive 216 is also applied to a second end of the heat shrink tube 214 such that the adhesive covers both the heat shrink tube 214 and at least a portion of the buffer tube 208 (block 116). The adhesive 216 may be the same as the adhesive that was applied at block 114.

Finally, at block 118 the adhesive is allowed to cure. In some embodiments, the adhesive is cured by application of an adhesive curing accelerator, such as SF-713 Loctite sold by Henkle AG & Co. KGaA. In another embodiment, no adhesive curing accelerator is applied and the adhesive 216 cures naturally over time.

In some embodiments, the one or more strength members 206 are not trimmed until after the adhesive 216 is cured. In such embodiments, the one or more strength members 206 may be pulled back toward the jacket 204 and away from the buffer tube 208 to provide easy access to the buffer tube. The one or more strength members 206 are then trimmed to length after the adhesive 216 is cured.

The demarcation is now formed at the end of the optical cable 202. At this point the optical cable is ready to be inserted into a connector housing of an optical connector. As described above, the demarcation prevents pre-buckling of the optical fibers within the optical connector before a final demarcation is provided by the addition of adhesive through the connector housing (i.e., potting).

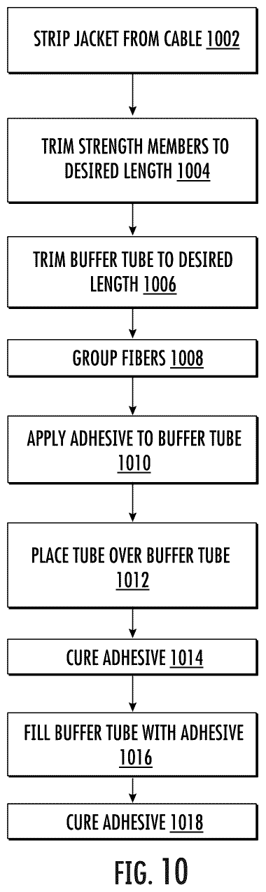

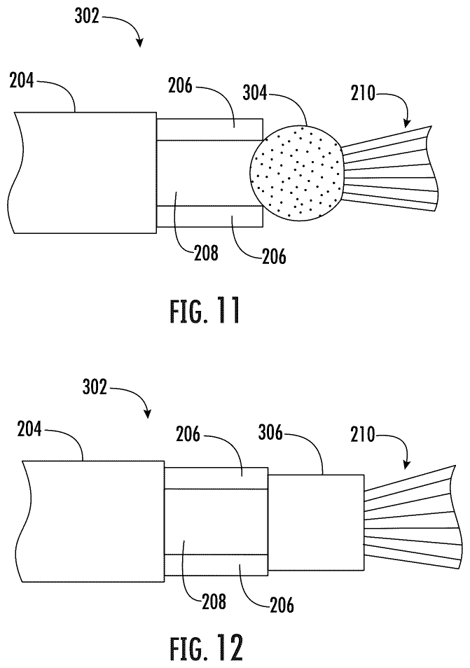

FIG. 10 is a flowchart illustrating another example method of forming a demarcation in a cable, such as an optical cable 302 (see FIG. 11). At block 1002 the jacket 204 is stripped from the optical cable 202. The optical cable 302 may be stripped by any method, such as by a cable stripping tool. Stripping the jacket 204 exposes the internal components of the optical cable 202, which includes a buffer tube 208 and one or more strength members 206. The one or more strength members 206 provide rigidity to the optical cable 202, and prevent it from being bent beyond an allowable bend radius. Embodiments are not limited by the number or type of strength members. As a non-limiting example, the one or more strength members 206 may be glass-reinforced plastic polyester. As other examples, the one or more strength members 206 may be aramid yarn or metal members.

At block 1004 the one or more strength members 206 are trimmed so that they extend from an end of the jacket 204 by a first distance d₁ (see FIG. 3). In some embodiments, the first distance d₁ is within a range of 5 mm to 10 mm, 6 mm to 9 mm, 6 mm to 8 mm, including endpoints, or 7 mm.

At block 1006 the buffer tube 208 is trimmed such that the it extends beyond an end of the one or more strength members 206 by a second distance d₂ (see FIG. 4). The length of the second distance d₂ determines the length of the demarcation. As non-limiting examples, the second distance d₂ may be 1 mm to 5 mm, 2 mm to 4 mm, 2.5 mm to 3.5 mm, including endpoints, or 3 mm.

The trimming of the buffer tube 208 exposes the plurality of optical fibers 210. Any gel that is present within the buffer tube 208 may be removed. This gel may be removed by use of a needle, for example. It should be understood that gel may not be provided within the buffer tube in some embodiments.

At block 1008 the plurality of optical fibers 210 may be optionally grouped into a desired order, such as the order the optical fibers 210 will be arranged within the optical connector. The plurality of optical fibers may be grouped by applying a clamp 212 (see FIG. 5). The clamp 212 may include a plurality of grooves (not shown) to receive the plurality of optical fibers 210 to group them without undue damage.

Next, at block 1010, adhesive 304 is applied to the buffer tube 208 defined by the second distance d₂ as shown in FIG. 11. As a non-limiting example, the adhesive may be Loctite® 411. However, other adhesives may also be utilized.

At block 1012 a tube 306 is disposed over the buffer tube 208 such that the adhesive 304 is disposed between the buffer tube 208 and the tube 306 (FIG. 11). Unlike the embodiment illustrated in FIG. 1 that uses a heat shrink tube 214, the tube 306 may be fabricated from a rigid material, such as rigid plastic, for example. At block 1014 the adhesive 304 is allowed to cure. In some embodiments, an adhesive curing accelerator is applied to the inside of the tube 306 to accelerate the curing of the adhesive. As a non-limiting example, Loctite® SF-712 may be used as an adhesive curing accelerator.

Next, at block 1016, the tube 306 and the buffer tube 208 are injected with adhesive 304 to secure the plurality of optical fibers 210 to the buffer tube 208 and the tube 306. At block 1018 the adhesive 304 is allowed to cure, either naturally or with an adhesive curing accelerator, such as Loctite® SF-712. This forms the demarcation of the optical cable 302 such that the optical cable is ready to be inserted into a connector housing of an optical connector. It is noted that in some embodiments the curing step at 1014 is skipped such that both the first adhesive and the second adhesive are cured in one step.

The optical cables described herein may be coupled to any type of optical connector. As a non-limiting example, the methods described herein can be used to prepare optical cables for coupling to male or female Pushlok® optical connectors sold by Corning Optical Communications of Charlotte, North Carolina. Embodiments of such Pushlok® optical connectors are described in US Pat. Publ. Nos. US2023/0204867, US2023/0204868, US2023/0213707, and 2023/2023/0258876. The optical cables may be round drop cables or flat drop cables (e.g., the SST-Drop™ cable sold by Corning Optical Communications).

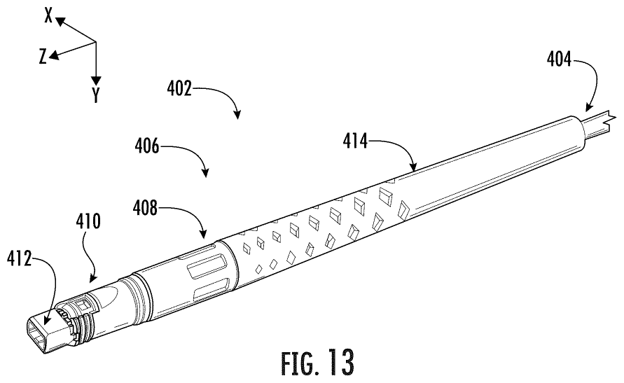

FIG. 13 illustrates an example optical cable assembly 402 having a flat SST-drop optical cable 404 and a Pushlok® optical connector 406. The optical connector 406 generally includes a nosepiece 412, a connector housing 410, and a boot 408. The connector housing 410 is coupled to the boot 408. The nosepiece 412 includes a ferrule retaining portion generally configured to hold and retain a multifiber ferrule (not shown) that is positioned at least partially within the ferrule retaining portion. The optical cable 404 having a demarcation formed by a preparation method as described above is coupled to the rear of the optical connector 406. In some embodiments, a final demarcation is formed by adding an adhesive to a passageway within the optical connector 406 to secure the optical fibers within the optical connector 406.

It should now be understood that embodiments of the present disclosure are directed to methods for preparing an optical cable for coupling to a connector that includes forming a pre-demarcation using an adhesive. This adhesive demarcation substantially minimizes the problem of pre-buckling of the optical fibers within the connector prior to the final potting of the fibers to the optical connector.

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application covers the modifications and variations provided they come within the scope of the appended claims and their equivalents.

1. A method of preparing an optical cable, the method comprising:
stripping a jacket of the optical cable to expose a buffer tube and one or more strength members;
trimming the one or more strength members to a first distance d₁ from an end of the jacket;
trimming the buffer tube to a second distance d₂ from an end of the one or more strength members to expose a plurality of optical fibers;
grouping the plurality of optical fibers;
applying a heat shrink tube over the buffer tube;
applying heat to the heat shrink tube;
applying adhesive to a first end and a second end of the heat shrink tube; and
curing the adhesive.

2. The method of claim 1, wherein:
the first end of the heat shrink tube is proximate the plurality of optical fibers and the adhesive covers a portion of the first end of the heat shrink tube and a portion of the plurality of optical fibers; and
the second end of the heat shrink tube is proximate the one or more strength members and the adhesive covers a portion of the second end of the heat shrink tube, a portion of the one or more strength members, and a portion of the buffer tube.

3. The method of claim 1, further comprising applying an adhesive curing accelerator to the adhesive at the first and second ends of the heat shrink tube.

4. The method of claim 1, wherein the one or more strength members comprises a first strength member and a second strength member.

5. The method of claim 1, wherein the one or more strength members comprises one or more glass-reinforced plastic polyester members.

6. The method of claim 1, further comprising, prior to applying the heat shrink tube, removing a gel within the buffer tube.

7. The method of claim 6, wherein the gel is removed from the buffer tube with a needle.

8. The method of claim 1, wherein the first distance d₁ is within a range of 6 millimeters to 8 millimeters, including endpoints.

9. The method of claim 1, wherein the second distance d₂ is within a range of 2.5 millimeters to 3.5 millimeters, including endpoints.

10. An optical cable prepared according to the method of claim 1.

11. An optical cable assembly comprising:
an optical cable prepared according to the method of claim 1; and
an optical connector, wherein the optical cable is secured within the optical connector.

12. A method of preparing an optical cable, the method comprising:
stripping a jacket of the optical cable to expose a buffer tube and one or more strength members;
trimming the one or more strength members to a first distance d₁ from an end of the jacket;
trimming the buffer tube to a second distance d₂ from an end of the one or more strength members to expose a plurality of optical fibers;
grouping the plurality of optical fibers at a location offset from the end of the one or more strength members to arrange the plurality of optical fibers into an order;
applying a first adhesive over the buffer tube;
applying a tube over the first adhesive and the buffer tube;
applying a second adhesive into the tube such that the second adhesive covers a portion of the plurality of optical fibers; and
curing the second adhesive.

13. The method of claim 12, further comprising applying an adhesive curing accelerator to the first adhesive to accelerate a curing of the first adhesive.

14. The method of claim 12, further comprising applying an adhesive curing accelerator to the second adhesive to accelerate a curing of the second adhesive.

15. The method of claim 12, wherein the one or more strength members comprises a first strength member and a second strength member.

16. The method of claim 12, wherein the one or more strength members comprises one or more glass-reinforced plastic polyester members.

17. The method of claim 12, further comprising, prior to applying the tube, removing a gel within the buffer tube.

18. The method of claim 17, wherein the gel is removed from the buffer tube with a needle.

19. The method of claim 12, wherein the first distance d₁ is within a range of 6 millimeters to 8 millimeters, including endpoints.

20. The method of claim 12, wherein the second distance d₂ is within a range of 2.5 mm to 3.5 millimeters, including endpoints.

21. The method of claim 12, further comprising curing the first adhesive prior to applying the second adhesive.

22. An optical cable prepared according to the method of claim 12.

23. An optical cable assembly comprising:
an optical cable prepared according to the method of claim 12; and
an optical connector, wherein the optical cable is secured within the optical connector.

24. A method of preparing an optical cable, the method comprising:
stripping a jacket of the optical cable to expose an end of a buffer tube and one or more strength members;
trimming the end of the buffer tube to a second distance d₂ from an end of the one or more strength members to expose a plurality of optical fibers;
grouping the plurality of optical fibers;
pulling the one or more strength members back toward the jacket;
applying a heat shrink tube over the buffer tube;
applying heat to the heat shrink tube;
applying adhesive to a first end and a second end of the heat shrink tube;
curing the adhesive; and
trimming the one or more strength members to a first distance d₁ from an end of the jacket.

25. The method of claim 24, wherein:
the first end of the heat shrink tube is proximate the plurality of optical fibers and the adhesive covers a portion of the first end of the heat shrink tube and a portion of the plurality of optical fibers; and
the second end of the heat shrink tube is proximate the one or more strength members and the adhesive covers a portion of the second end of the heat shrink tube, a portion of the one or more strength members, and a portion of the buffer tube.

26. The method of claim 24, further comprising, prior to applying the heat shrink tube, removing a gel within the buffer tube.

27. The method of claim 26, wherein the gel is removed from the buffer tube with a needle.

28. The method of claim 24, wherein the first distance d₁ is within a range of 6 millimeters to 8 millimeters, including endpoints.

29. The method of claim 24, wherein the second distance d₂ is within a range of 2.5 millimeters to 3.5 millimeters, including endpoints.

30. An optical cable comprising:
a jacket;
one or more strength members within the jacket and extending beyond an end of the jacket by a first distance d₁;
a buffer tube within the jacket, wherein the buffer tube extends beyond an end of the one or more strength members by a second distance d₂;
a plurality of optical fibers within the buffer tube and extending beyond an end of the buffer tube;
a tube disposed around the buffer tube; and
an adhesive disposed around at least a first end and a second end of the heat shrink tube.

31. The optical cable of claim 30, wherein the one or more strength members comprises a first strength member and a second strength member.

32. The optical cable of claim 30, wherein the one or more strength members comprises one or more glass-reinforced plastic polyester members.
